(19) United States
(12) Patent Application Publication
(10) Pub. No.: US 2007/0165586 A1
(43) Pub. Date: Jul. 19, 2007

(54) Quiet periods for detecting wireless devices

(75) Inventors: James Laurence Taylor, Sherbourne (GB); Nishant Kumar, San Diego (CA); Joseph William Long, Oceanside, CA (US)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/605,845

(22) Filed: Nov. 28, 2006

Related U.S. Application Data
(60) Provisional application No. 60/740,841, filed on Nov. 29, 2005.

(51) Int. Cl. H04Q 7/24

(52) U.S. Cl. 370/338

(57) ABSTRACT

A communication is received that includes information regarding a quiet period on a wireless logical channel. During the quiet period, transmissions are refrained from occurring on the wireless logical channel. At least one device performs a process to detect wireless devices, if any, on the wireless logical channel during at least part of the quiet period.

### CROSS REFERENCE TO OTHER APPLICATIONS

This application claims priority to U.S. Provisional Patent Application No. 60/740,841 entitled QUIET PERIODS IN DETECTION AND AVOIDANCE filed Nov. 29, 2005 which is incorporated herein by reference for all purposes.

### BACKGROUND OF THE INVENTION

To mitigate interference between the increasing number of wireless devices, a variety of detection and avoidance schemes have been developed. Typically, this involves detecting a transmission from another wireless device. The detected wireless device is then avoided using time and/or frequency techniques, such as having an interfering wireless device refrain from transmitting at certain times and/or at certain frequencies.

FIG. 1 illustrates a scenario in which a wireless device being interfered with is silent. In the example shown, terminal 102 and base station 100 are associated with a first wireless system and/or first wireless communication protocol, specification, or standard. For example, base station 100 and terminal 102 may be WiMax wireless devices. Wireless devices 104 - 107 are associated with a second wireless system and/or a second wireless specification, such as ultra wideband (UWB).

In this example, terminal 102 is located relatively far from base station 100 and is located relatively close to wireless devices 104-107. Terminal 102 is configured to transmit only when certain transmissions are received from base station 100. In some cases, interference from wireless devices 104-107 causes terminal 102 to not receive transmissions from base station 100. Terminal 102 may thus not be able to transmit, and wireless device 104-107 will be unable to detect and avoid terminal 102. Techniques to detect wireless devices in scenarios such as this would be useful.

### BRIEF DESCRIPTION OF THE DRAWINGS

Various embodiments of the invention are disclosed in the following detailed description and the accompanying drawings.

FIG. 1 illustrates a scenario in which a wireless device being interfered with is silent.

FIG. 2 is a diagram illustrating an embodiment of using a beacon to announce a quiet period.

FIG. 3A is a diagram illustrating an embodiment of the propagation of a quiet period across a group of wireless devices.

FIG. 3B is a diagram illustrating an embodiment of beacons transmitted by a group of wireless devices.

FIG. 4A is diagram illustrating a quiet period information element with a time to live field.

FIG. 4B is a diagram illustrating an embodiment of a quiet period information element with an owner/reflector field.

FIG. 5 is a diagram illustrating two examples of logical channels.

FIG. 6 is a flowchart illustrating an embodiment of a process for establishing a quiet period on a logical channel.

FIG. 7A is a diagram illustrating an example of logical channels with quiet periods that are not aligned.

FIG. 7B is a diagram illustrating an embodiment of aligned quiet periods.

FIG. 8A is a diagram illustrating an example of quiet periods in an initial, unaligned state.

FIG. 8B is a diagram illustrating an example in which a quiet period expected to be moved is not moved.

FIG. 8C is a diagram illustrating an embodiment of aligned quiet periods in which one quiet period did not move.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

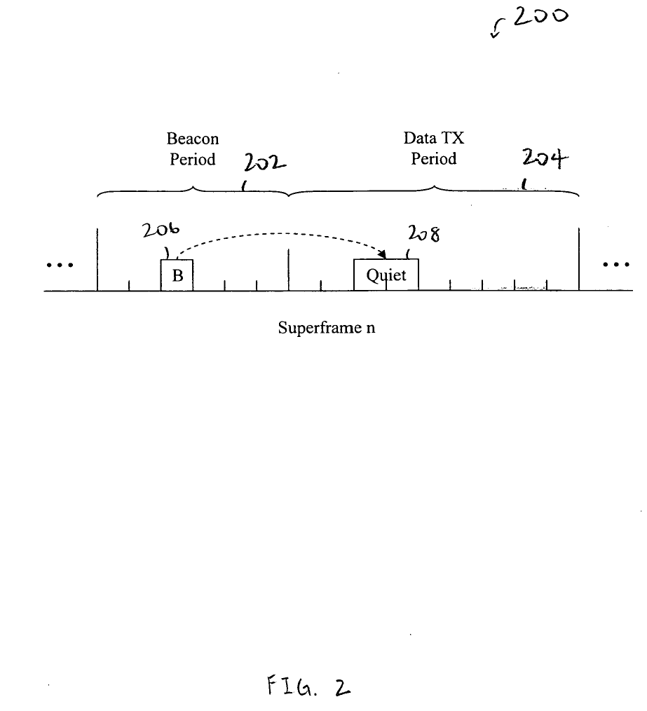

FIG. 2 is a diagram illustrating an embodiment of using a beacon to announce a quiet period. In the example shown, time is divided into superframes. Superframe n (200) is shown in this example. It is preceded by superframe n−1 (not shown) and is followed by superframe n+1 (not shown). Superframe n (200) includes beacon period 202 and data transmission period 204. During the beacon period, beacons are transmitted by the wireless devices and are used to exchange control and/or management related information. Data transmission period 204 is used to exchange data between wireless devices. Beacon period 202 includes a plurality of beacon slots and data transmission period 204 includes a plurality of data slots or medium access slots. The slots and periods shown in this figure are exemplary and are not necessarily to scale. For example, the number of slots may vary from the example shown and/or a beacon slot may not necessarily be the same duration as a data slot.

In some embodiments, a wireless standard, protocol, or specification defines a plurality of logical channels that a wireless device is permitted to operate on. In some embodiments, a superframe structure is established and maintained on each logical channel.

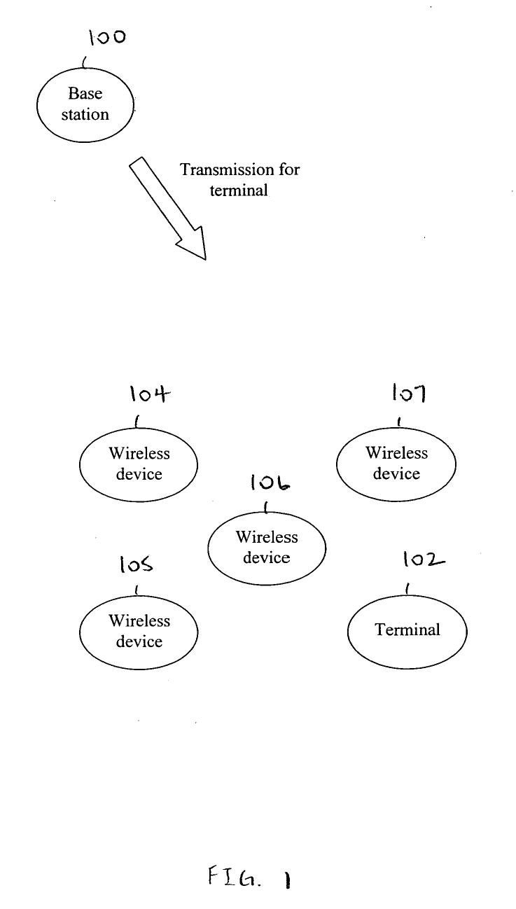

In this example, silent periods are established and/or communicated using beacons. Beacon 206 is transmitted in the third beacon slot of beacon period 202 and is used to announce or otherwise reserve time for quiet period 208. A wireless device that receives and properly decodes beacon 206 will refrain from transmitting during quiet period 208. This may enable a wireless device being interfered with (e.g., terminal 102 in FIG. 1) to be able to transmit a signal during quiet period 208. For example, there may be a significant amount of traffic exchanged during data transmission period 204 and a high activity level may prevent a wireless device being interfered with from being detected. Wireless devices that receive beacon 206 will not transmit during quiet period 208 and will be able to detect and avoid the wireless device being interfered with. Any particular signal processing technique to detect a wireless device during quiet period 208 and/or to subsequently mitigate or avoid interfering with a detected wireless device may be used.

In some embodiments, beacon 206 includes a general or unspecific reservation, such as a data reservation information element. For example, wireless devices may be able to reserve slots in data transmission period 204 to reserve time to exchange data over the wireless medium, and this type of data reservation is used. In some embodiments, beacon 206 includes a special reservation type distinct from a regular data reservation, such as a quiet period information element. Wireless devices that receive a beacon with this special type of indicator may, for example, determine that it is appropriate to perform a detection process during quiet period 206.

In some embodiments, a wireless device interfered with is a WiMax wireless device. In some embodiments, a group of wireless devices that use beacons to communicate quiet period related information are ultra wideband (UWB) devices, such as WiMedia UWB devices. Although some of the examples described herein may discuss certain wireless specifications (e.g., WiMedia UWB), the techniques disclosed herein are not limited to any particular wireless specification.

In some embodiments, a wireless device that transmits a communication about a quiet period is configured to operate according to a first wireless specification or standard and a wireless device that receives the communication (and respects the quiet period) is configured to operate according to a second wireless specification. In some embodiments, the transmitting wireless device is configured to transmit communications encoded, formatted, or otherwise generated according to the second (i.e., receiving) wireless specification. In some embodiments, there is some special communication, format, or mechanism for communicating quiet period information between different types of wireless specifications. For example, a standard may be defined for communicating quiet period information between different types of wireless specifications or standards.

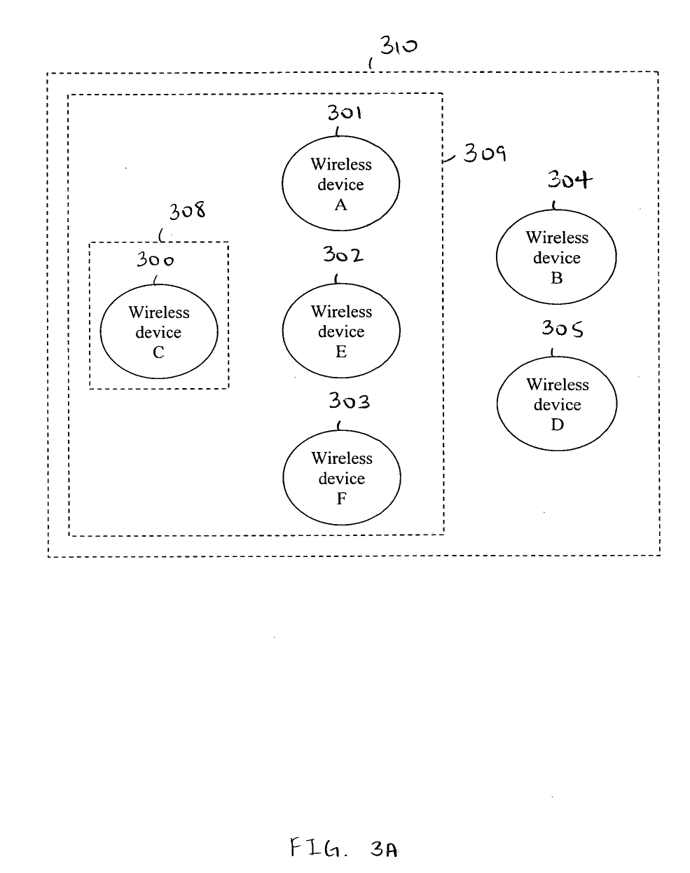

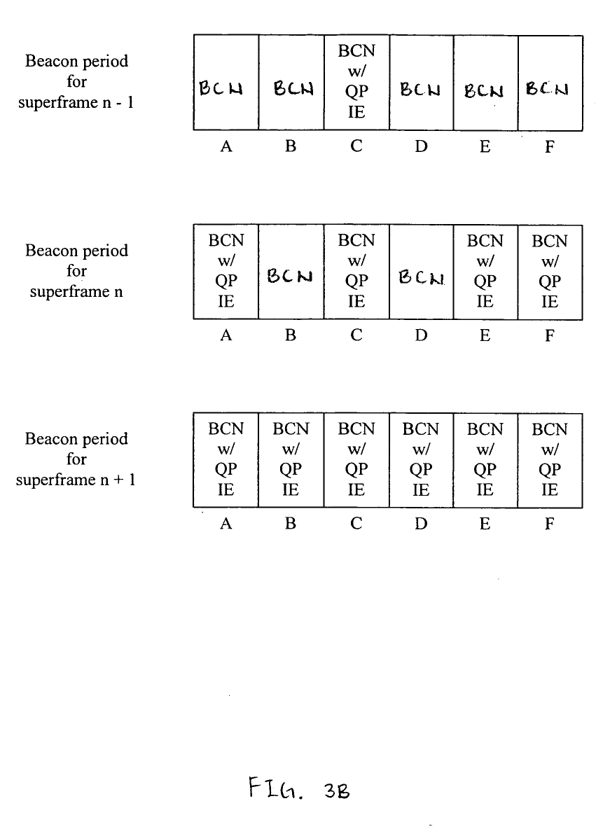

FIG. 3A is a diagram illustrating an embodiment of the propagation of a quiet period across a group of wireless devices. In the example shown, wireless devices 300-305 communicate with each other on the same logical channel. Each wireless device is expected to transmit a beacon during the beacon period of a superframe. However, some wireless devices are not able to hear some other wireless devices, for example because the distance between them is too great. In this example, wireless device B and D (304 and 305) are not able to properly receive and decode beacons from wireless device C (300).

Wireless device C (300) decides to start a quiet period on the logical channel used by this group of wireless devices. Groups 308-310 show the spread of quiet period information across this group of wireless devices. At first, 308 includes only wireless device C (300). To communicate the quiet period to other wireless devices, wireless device C (300) transmits a beacon that includes quiet period information. Wireless devices A, E, and F (301-303) receive that beacon with quiet period information and will refrain from transmitting during the quiet period. Group 309 therefore includes wireless device C, A, E, and F (300-303).

At the next beacon period, wireless devices A, E, and F (301-303) all transmit beacons with appropriate quiet period information, in addition to the second beacon transmitted with quiet period information by wireless device C (300). Wireless devices B and D (304 and 305) which are not able to receive beacons from wireless device C (300) receive at least one beacon with quiet period information from wireless devices A, E, and/or F (301-303) and are thus now aware there is a quiet period and will refrain from transmitting during the quiet period. Group 310 thus includes wireless device A-F (300-305). At the next beacon period, the beacons transmitted by wireless devices B and D (304 and 305) will contain quiet period information, as will the beacons transmitted by wireless devices C, A, E, and F (300-303).

As the initiator of the silent period, wireless device C (300) is referred to as the owner of the silent period. Wireless devices A, E, F, B, and D (301-305) spread the silent period information and are referred to as reflectors. In some embodiments, only an owner of a silent period has certain privileges with respect to the silent period. For example, some systems are configured so that only an owner is permitted to move a silent period, expand/contract the duration of a silent period, etc. In some embodiments, reflectors merely propagate silent period information to other wireless devices.

By having wireless devices that receive quiet period information act as reflectors, it may be possible to have all wireless devices on a logical channel respect a silent period, even if some wireless devices are unable to hear some other wireless devices. In some cases, all wireless devices are able to hear all other wireless devices, but due to the lossy wireless medium, beacons are occasionally lost. It may be useful to have multiple wireless devices communicate quiet period information since the likelihood of losing multiple beacons at the same time is relatively small.

FIG. 3B is a diagram illustrating an embodiment of beacons transmitted by a group of wireless devices. In the example shown, the transmitted beacons correspond to the example of FIG. 3A. For convenience, wireless device A (301) transmits during the first beacon slot, wireless device B (304) transmits during the second beacon slot, etc. In some cases there may be a different mapping of wireless devices to beacon slots, there may be unused beacon slots, there may be a different number of beacon slots in a beacon period, etc.

During the beacon period of superframe n−1, each of the wireless devices transmits a beacon during its respective beacon slot. The beacon transmitted in the third beacon slot by wireless device C includes a quiet period information element (IE) used to communicate quiet period related information. Information elements are used to communicate control and/or management related information in the body of a beacon, and the quiet period IE is used to exchange quiet period related information. Some examples of quiet period IEs are described in further detail below.

At superframe n, wireless devices A, C, E, and F transmit beacons with quiet period IEs during the first, third, fifth, and sixth beacon slots, respectively. Wireless devices B and D did not receive the beacon with the quiet period IE transmitted by wireless device C and their beacons do not include a quiet period IE. At the beacon period of superframe n+1, all wireless devices are transmitting beacons with quiet period IEs.

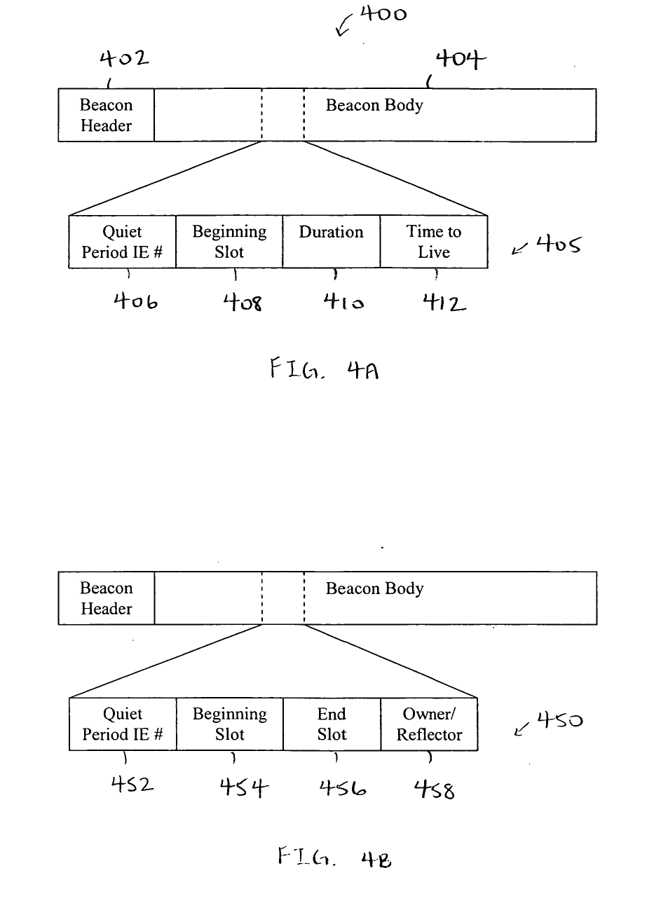

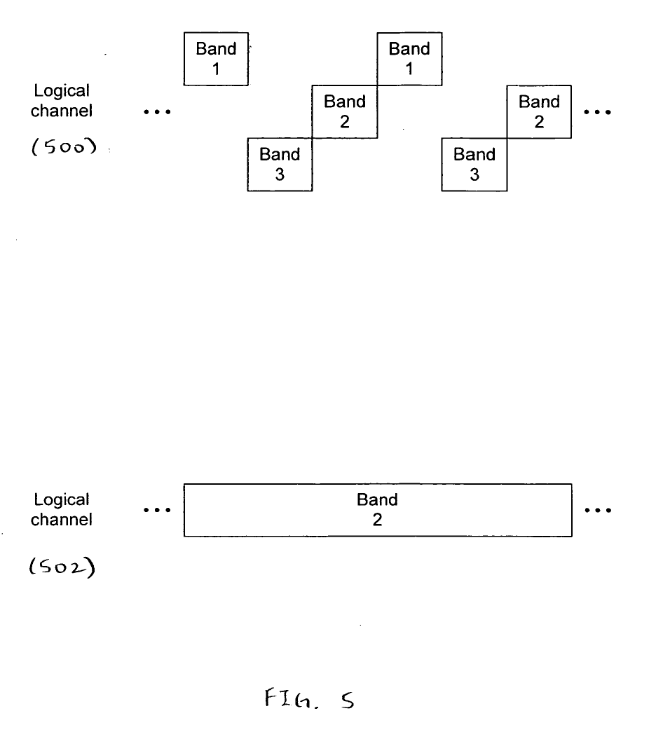

FIG. 4A is diagram illustrating a quiet period information element with a time to live field. In the example shown, beacon frame 400 includes beacon header 402 and beacon body 404. Beacon body 404 includes a variety of information elements, some of which are optional. Quiet period IE 405 includes quiet period IE number 406, beginning slot 408, duration field 410, and time to live field 412. In this example, quiet period IE number 406 is a number that uniquely identifies the information element as being a quiet period IE. In this example, the quiet period IE is optional and not every beacon will include it. Beginning slot 408 identifies the first slot of the quiet period and duration field 410 is the duration of the quiet period, for example in units of slots. Time to live field 412 indicates how long a quiet period is in effect for. For example, the time to live value may be in units of superframes and this count is decremented (e.g., by a silent period owner and/or reflector) at each superframe.

In some applications, using a time to live field is attractive. For example, there may be a significant amount of traffic and it may be desirable to end the quiet period after a certain amount of time in order to exchange data during that time. In some applications, using a time to live is attractive since all wireless devices performing detection stop at the same time. For example, if a wireless device believes there is a quiet period when there is none, that wireless device may erroneously detect a wireless device and with certain detection/avoidance schemes this erroneous detection may be communicated to other devices.

FIG. 4B is a diagram illustrating an embodiment of a quiet period information element with an owner/reflector field. In the example shown, quiet period IE 450 is an alternative to quiet period IE 405 in FIG. 4A. In this embodiment, quiet period IE 450 includes quiet period IE number 452, beginning slot 454, end slot 456, and owner/reflector field 458. Quiet period IE number 452 and 406 are similar and are used to identify the information element as being a quiet period IE. Beginning slot 454 and end slot 456 are the first and last slots, respectively, that define the boundaries of the quiet period. Owner/reflector field 458 is used to indicate whether the transmitting wireless device is the owner or a reflector of a quiet period. For example, wireless device C (300) of FIG. 3A would set this field to a value indicating that it is the owner, and wireless devices A, E, F, B, and D (301-305) would set this field to a value indicating they are reflectors.

FIGS. 4A and 4B show some embodiments of quiet period information elements. In some embodiments, a quiet period IE includes some other combination of fields. In some embodiments, a wireless device uses some other type of information element to reserve a quiet period (e.g., a data reservation IE).

In some embodiments, quiet periods are established or otherwise managed on two or more logical channels. The following figures show some examples of logical channels and some examples for establishing and managing quiet periods on multiple logical channels.

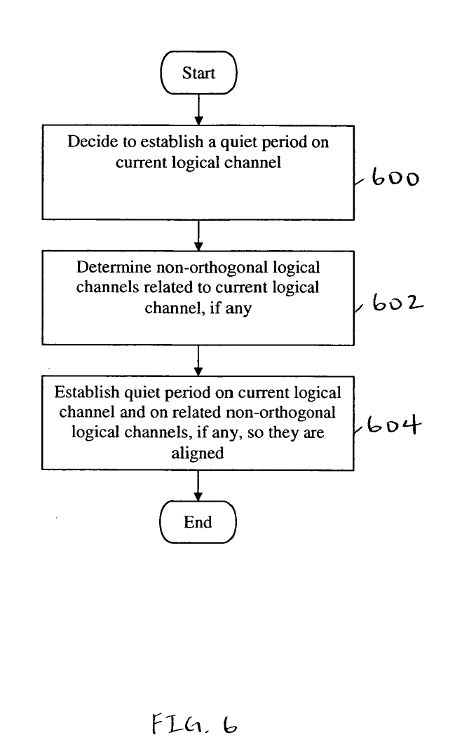

FIG. 5 is a diagram illustrating two examples of logical channels. In the example shown, logical channel 500 is associated with band hopping where a pattern of hop bands is repeated. For example, the WiMedia UWB specification permits the use of band hopping, which is also referred to as Time Frequency Interleaving (TFI). The WiMedia UWB specification and other specifications define permitted hop patterns. The hop pattern in logical channel 500 is (band 1, band 3, band 2) and this hop pattern is repeated. Bands 1, 2, and 3 (used in logical channel 500) do not overlap in frequency in this example. In some embodiments, bands and/or logical channels vary from these examples. For example, bands may overlap in frequency, or some other hop pattern and/or number of bands is used.

In various embodiments, the amount of time spent on a band varies. For example, for TFI channels in the WiMedia UWB specification, the amount of time spent on each band corresponds to the duration of an Orthogonal Frequency Division Multiplexing (OFDM) symbol. In some embodiments, some other duration of time is spent on a given band. For example, a wireless device may transmit a frame or a packet on a given band and then change to another band or always transmit in the same band.

Logical channel 502 comprises of a single band (i.e., band 2). The WiMedia UWB specification permits the use of a logical channel with a single band and refers to it as Fixed Frequency Interleaving (FFI).

Logical channels 500 and 502 both include band 2 and are not orthogonal to each other. In some embodiments, a quiet period is established on two or more logical channels that are not orthogonal to each other (e.g., logical channels 500 and 502). In some embodiments, quiet periods on two logical channels are aligned so that they overlap in time. Although some examples described herein discuss quiet periods with respect to two or more non-orthogonal logical channels, in some embodiments, quiet periods are established on two or more logical channels that are orthogonal or are otherwise not related. In some cases, for example, it is impossible to know in advance which logical channels other wireless devices will operate on. It may be desirable to occasionally go through all logical channels (e.g., one at a time or in groups of logical channels) and create quiet periods to periodically detect any silent wireless devices.

In some embodiments, band groups define non-orthogonal bands or bands that are otherwise related. Table 1 shows bands and band groups defined by the WiMedia UWB specification. In WiMedia UWB, bands are non-overlapping frequency ranges that are identified by a band ID. A band group includes two or more bands.

TABLE 1
WiMedia UWB Bands

| | | Center |
|---|---|---|
| Band Group | Band ID | Frequency |
| 1 | 1 | 3.432 GHz |
| | 2 | 3.960 GHz |
| | 3 | 4.488 GHz |
| 2 | 4 | 5.016 GHz |
| | 5 | 5.544 GHz |
| | 6 | 6.072 GHz |
| 3 | 7 | 6.600 GHz |
| | 8 | 7.128 GHz |
| | 9 | 7.656 GHz |
| 4 | 10 | 8.184 GHz |
| | 11 | 8.712 GHz |
| | 12 | 9.240 GHz |
| 5 | 13 | 9.768 GHz |
| | 14 | 10.296 GHz |
| 6 | 9 | 7.656 GHz |
| | 10 | 8.184 GHz |
| | 11 | 8.712 GHz |

In the WiMedia UWB specification, logical channels associated with band hopping use bands from a single band group. For example, a logical channel in WiMedia UWB would not be permitted to include bands 1, 2, and 4 since bands 1 and 2 are associated with band group 1 and band 4 is associated with band group 2. In some embodiments, relationships between with logical channels, band groups, and/or bands are used to determine a group of one or more logical channels to establish a quiet period on. For example, when determining which logical channels are non-orthogonal or are related to a particular logical channel or band, band groups may be considered.

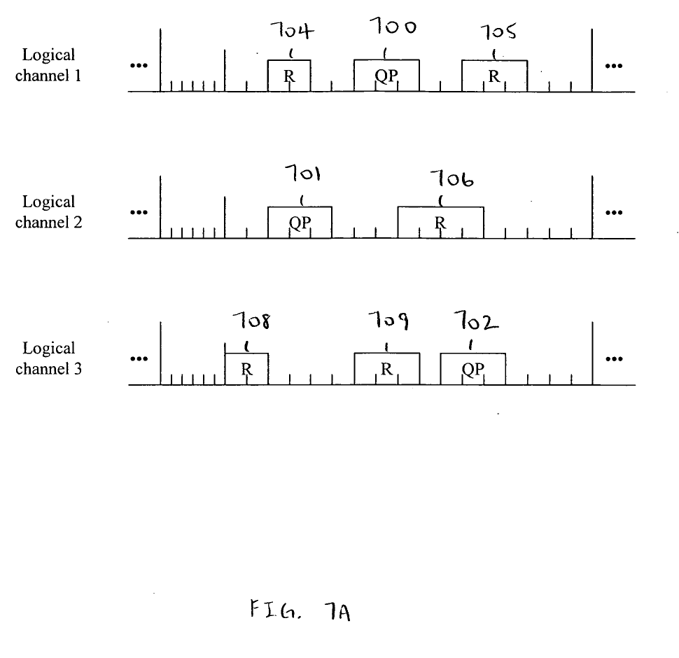

FIG. 6 is a flowchart illustrating an embodiment of a process for establishing a quiet period on a logical channel. In some embodiments, a process for determining whether to establish or otherwise start a quiet period is a distributed process (e.g., performed by multiple wireless devices rather than a single device). Using a distributed process may be attractive in some applications since wireless devices often leave a group unexpectedly in a wireless environment. In some embodiments, once a quiet period is established, an owner is responsible for any changes to the quiet period (e.g., expanding/contracting the duration, moving the quiet period, etc.) until the quiet period expires (e.g., a time to live field is decremented to zero).

At 600, it is decided to establish a quiet period on a current logical channel. For example, the current logical channel may be the logical channel a wireless device performing the example process is operating on. In some embodiments, the decision at 600 is time based. A wireless device may, for example, have a timer that starts running when a quiet period ends. If another wireless device starts a quiet period (e.g., a beacon with a quiet period IE is received from another wireless device), the timer is reset. However, if the timer exceeds a certain amount of time the wireless device decides to start a quiet period. This is one example for deciding to start a quiet period. In some embodiments, some other factor (e.g., as an alternative to or in addition to time) is used at 600. For example, a device may be instructed to initiate a quiet period on a current channel.

Non-orthogonal logical channels related to a current logical channel, if any, are determined at 602. In some embodiments, logical channels are related because they share at least one band in common (e.g., FIG. 5). In some embodiments, a wireless specification permits two more bands to overlap and bands are related because they share some frequency spectrum in common.

At 604, a quiet period is established on a current logical channel and on related non-orthogonal logical channels, if any, so they are aligned. In some embodiments, a wireless device performing the example process transmits beacons with quiet period information elements on all appropriate logical channels.

In some cases, quiet periods are established on two or more logical channels but they are not aligned and it is desirable for them to be aligned. For example, one group of wireless devices may have started a quiet period and then another group of wireless devices on a non-orthogonal logical channel enters the vicinity of the first group of wireless devices. The following figures illustrate some embodiments for handling such a scenario.

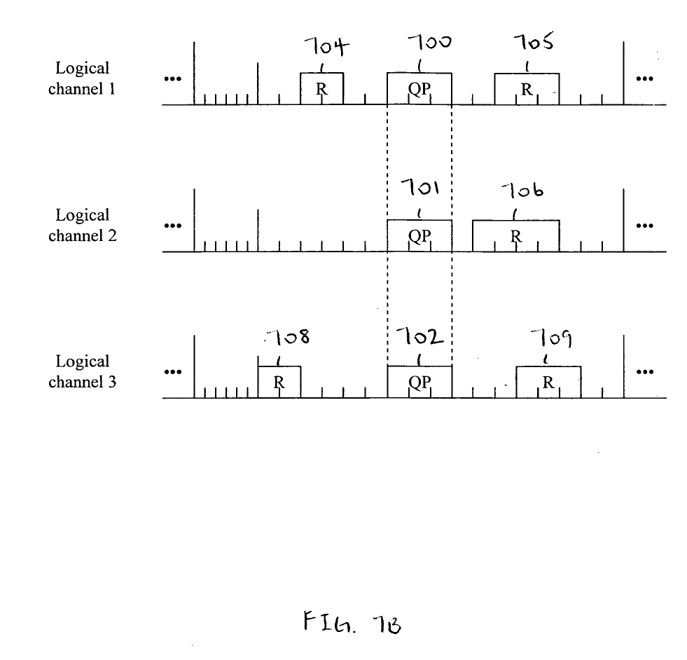

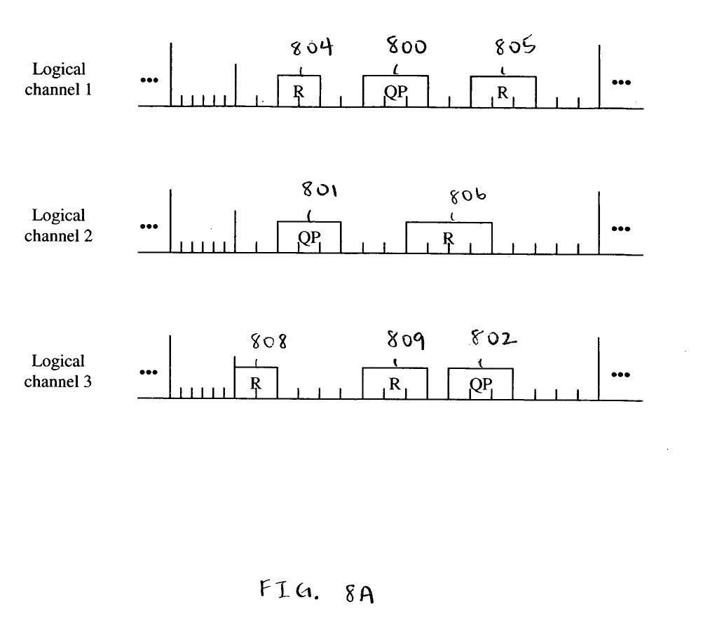

FIG. 7A is a diagram illustrating an example of logical channels with quiet periods that are not aligned. In the example shown, logical channels 1, 2, and 3 are non-orthogonal and it is desirable for quiet periods 700-702 to be aligned. For convenience, beacons are not shown although they may be used to communicate the data reservations and/or quiet periods shown.

In this example, the quiet period with the highest priority is the one to which the other quiet periods align themselves to. Each logical channel in this example is assigned a number (i.e., 1, 2, and 3) and the logical channel with the lowest number has the highest priority (i.e., logical channel 1). In some embodiments, some other factor is used to determine priority. Some examples include the age (i.e., how long ago a quiet period was established), the traffic load of a particular logical channel (i.e., how difficult/easy it would be to move that logical channel's quiet period), etc.

Quiet periods 701 and 702 align themselves directly to quiet period 700 in this example. For example, the movement of quiet period 702 does not necessarily dependent upon quiet period 701 first moving. In some embodiments, quiet periods are moved in daisy chain or sequential fashion where quiet period 702 aligns itself with quiet period 701, and quiet period 701 aligns itself with quiet period 700 in turn.

In some embodiments, the owner of a silent period is responsible for determining that an associated quiet period should be moved and/or is responsible for coordinating or initiating the move. For example, the owners of quiet periods 700-702 may each determine whether their respective quiet period should be moved. In some embodiments, an owner of a quiet period waits for a quiet period to expire and when the quiet period is subsequently started it is aligned with an appropriate quiet period on another logical channel. In some embodiments, a quiet period is moved before an associated time to live expires.

FIG. 7B is a diagram illustrating an embodiment of aligned quiet periods. In the example shown, quiet periods 701 and 702 have been moved from their previous positions shown in FIG. 7A so that they are aligned with quiet period 700. Data reservations 706 and 709 have also moved to accommodate the new positions of quiet periods 701 and 702, respectively. Any appropriate technique may be used to move data reservations.

In the examples of FIGS. 7A and 7B, the superframes are aligned across logical channels. That is, the beacon period start times (i.e., the beginning of the beacon period) of logical channels 1, 2, and 3 occur at the same time. In some embodiments, the beacon period start times do not occur at the same time and the techniques disclosed herein are modified (if needed) to accommodate unaligned beacon period start times.

In some cases, a quiet period with a lower priority is not moved. This can occur for a variety of reasons. For example, a logical channel may be used to exchange high priority traffic and it is not desirable to move or cancel an associated data reservation. In some cases, one or more wireless devices are unaware there is a quiet period with a higher priority. For example, wireless devices on logical channels 1 and 2 may be located so they are unable to properly receive and decode information from wireless devices on the other logical channel. Wireless devices on logical channel 2 may thus believe they have the highest priority quiet period and do not move their quiet period to align with that of logical channel 1. The following figures illustrate some embodiments for handling scenarios such as these.

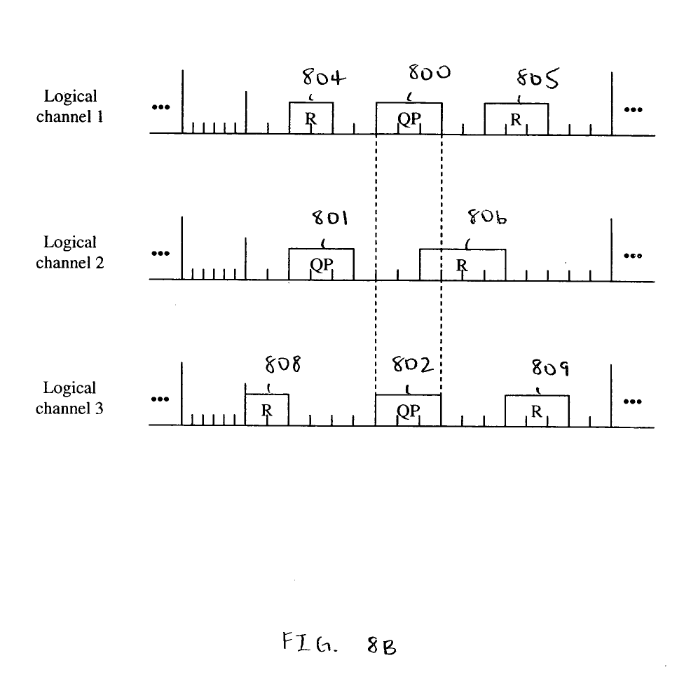

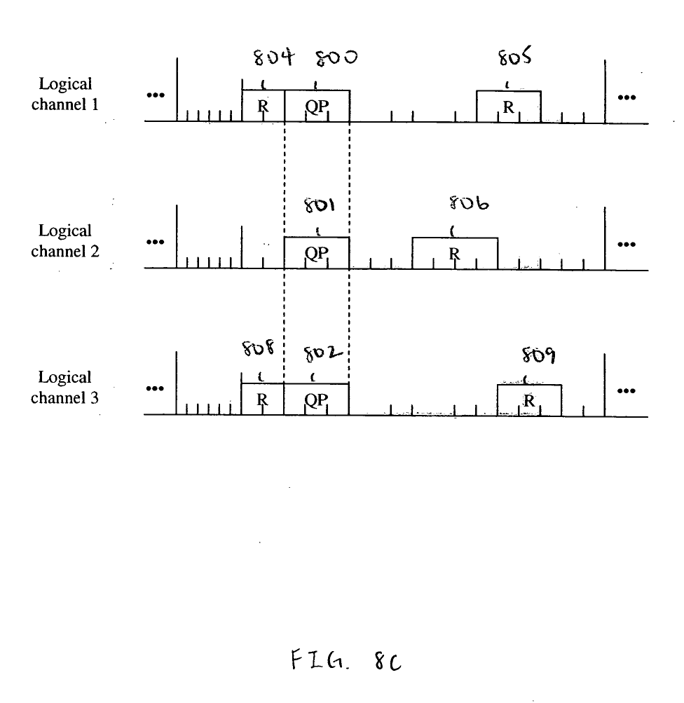

FIG. 8A is a diagram illustrating an example of quiet periods in an initial, unaligned state. In the example shown, quiet periods 800, 801, and 802 are associated with logical channels 1, 2, and 3 (respectively) and it is desirable that the quiet periods be aligned in time. In the example shown, quiet period 800 has the highest priority and quiet periods 801 and 802 should shift to align themselves with quiet period 800. For convenience, beacons associated with the example data reservations and example quiet periods are not shown.

FIG. 8B is a diagram illustrating an example in which a quiet period expected to be moved is not moved. In the example shown, quiet period 802 has been shifted and is properly aligned with quiet period 800. However, quiet period 801 has not moved from the state shown in FIG. 8A and still occupies slots 3-5. In some cases, wireless device(s) on logical channel 2 are unable to properly receive information from logical channel 1. The two groups of wireless devices may, for example, be located too far apart from each other and thus quiet period 801 is not moved. In some cases, a quiet period is not moved for some other reason, for example because a desired or new position for the quiet period is already occupied by a data reservation that cannot be moved and/or cancelled.

In the example shown, a time threshold to move quiet period 801 is exceeded and wireless devices associated with logical channel 1 and 3 conclude or otherwise determine that quiet period 801 will not be moved. A time threshold may be predetermined, configurable, user specified, or implemented/configured in any appropriate way.

FIG. 8C is a diagram illustrating an embodiment of aligned quiet periods in which one quiet period did not move. In the example shown, wireless devices associated with logical channels 1 and 3 have determined that a time threshold for moving quiet period 801 has been exceeded. Since it is unlikely that quiet period 801 will be moved to align all three quiet periods, quiet periods 800 and 802 have been moved so they align with quiet period 801. In the case of logical channel 1, data reservation 804 has been moved from slots 3 and 4 (shown in FIG. 8B) to slots 1 and 2 (shown in FIG. 8C) so that quiet period 800 can occupy slots 3-5 and thus align itself with quiet period 801. In the case of logical channel 3, no data reservation needs to be moved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for creating a quiet period, comprising:
receiving a communication that includes information regarding a quiet period on a wireless logical channel; and
during the quiet period, refraining from transmitting on the wireless logical channel, wherein at least one device performs a process to detect wireless devices, if any, on the wireless logical channel during at least part of the quiet period.

2. A method as recited in claim 1, wherein the communication includes a beacon.

3. A method as recited in claim 1, wherein the information is included in a quiet period information element (IE).

4. A method as recited in claim 1, wherein the information includes one or more slots during which the quiet period occurs.

5. A method as recited in claim 1, wherein the information includes a time to live.

6. A method as recited in claim 1 further comprising in the event the communication is not received within a time threshold, deciding to initiate the quiet period by transmitting the communication.

7. A method as recited in claim 1 further comprising in the event the communication is received, acting as a reflector by forwarding the information regarding the quiet period.

8. A method as recited in claim 1, wherein:
the quiet period is a first quiet period and the wireless logical channel is a first wireless logical channel; and
there is a second quiet period on a second wireless logical channel during which a receiving device that receives a second communication regarding the second quiet period refrains from transmitting on the second wireless logical channel.

9. A method as recited in claim 8, wherein the first wireless logical channel and the second wireless logical channel are not orthogonal to each other.

10. A method as recited in claim 8, wherein the first quiet period and the second quiet period overlap temporally.

11. A method as recited in claim 8, wherein in the event the first quiet period and the second quiet period do not overlap temporally then the method further comprises:
at one or more devices associated with the first quiet period, determining whether to move the first quiet period;
at one or more devices associated with the second quiet period, determining whether to move the second quiet period; and
moving the first quiet period and/or the second quiet period so that the first quiet period and the second quiet period overlap temporally.

12. A method as recited in claim 11, further comprising:
at one or more devices associated with either the first quiet period or the second quiet period, determining that a time threshold to move the other quiet period has been exceeded; and
moving said either first quiet period or second quiet period so that the first quiet period and the second quiet period overlap.

13. A method as recited in claim 1, wherein the communication is transmitted by a device operating according to a first wireless specification and the communication is received by a device operating according to a second wireless specification.

14. A system for creating a quiet period, comprising:
a receiver configured to receive a communication that includes information regarding a quiet period on a wireless logical channel; and
a transmitter configured to refrain from transmitting on the wireless logical channel during the quiet period, wherein at least one device performs a process to detect wireless devices, if any, on the wireless logical channel during at least part of the quiet period.

15. A system as recited in claim 14 further comprising in the event the communication is not received within a time threshold, deciding to initiate the quiet period by transmitting the communication.

16. A system as recited in claim 14 further comprising in the event the communication is received, acting as a reflector by forwarding the information regarding the quiet period.

17. A system as recited in claim 14, wherein:
the quiet period is a first quiet period and the wireless logical channel is a first wireless logical channel; and
there is a second quiet period on a second wireless logical channel during which a receiving device that receives a second communication regarding the second quiet period refrains from transmitting on the second wireless logical channel.

18. A system as recited in claim 17, wherein the first quiet period and the second quiet period overlap temporally.

19. A computer program product for creating a quiet period, the computer program product being embodied in a computer readable medium and comprising computer instructions for:
receiving a communication that includes information regarding a quiet period on a wireless logical channel; and
during the quiet period, refraining from transmitting on the wireless logical channel, wherein at least one device performs a process to detect wireless devices, if any, on the wireless logical channel during at least part of the quiet period.

20. A computer program product as recited in claim 19, the computer program product further comprising computer instructions for deciding to initiate the quiet period by transmitting the communication, in the event the communication is not received within a time threshold.

21. A computer program product as recited in claim 19, the computer program product further comprising computer instructions for acting as a reflector by forwarding the information regarding the quiet period, in the event the communication is received.

22. A computer program product as recited in claim 19, wherein:
the quiet period is a first quiet period and the wireless logical channel is a first wireless logical channel; and
there is a second quiet period on a second wireless logical channel during which a receiving device that receives a second communication regarding the second quiet period refrains from transmitting on the second wireless logical channel.

23. A computer program product as recited in claim 22, wherein the first quiet period and the second quiet period overlap temporally.
